(19) United States
(12) Patent Application Publication
(10) Pub. No.: US 2023/0132430 A1
(43) Pub. Date: May 4, 2023

(54) ADJUSTABLE APERTURE FOR AN OPTICAL BEAM PATH

(71) Applicant: CARL ZEISS MICROSCOPY GMBH, Jena (DE)

(72) Inventor: Daniel Stegmann, Großschwabhausen (DE)

(21) Appl. No.: 18/052,389

(22) Filed: Nov. 3, 2022

(30) Foreign Application Priority Data
Nov. 4, 2021 (DE) 10 2021 212 411.9

(51) Int. Cl. G02B 26/04; G02B 5/00

(52) U.S. Cl. CPC G02B 26/04; G02B 5/005

(57) ABSTRACT

An adjustable stop includes stop elements, each being movable in a stop plane that extends laterally from a through axis of the stop. Portions of a periphery of each stop element delimit an aperture around the axis based on current set positions of the element. Drives are configured for setting the set positions of the elements. Each element is embodied as a cam disk or a sector of a cam disk, which is rotatable about an axis parallel to the through axis. Each element has a differently shaped peripheral segments so that the current set position of the element configured to set a selected size and/or shape of the aperture, such that a desired peripheral segment of the element forms a portion of the delimitation of the aperture. Radial distances of the peripheral segments of an element increase over an angular range of the element toward the axis of rotation.

### CROSS REFERENCE TO RELATED APPLICATION

This application claims the priority to German Application No. DE 10 2021 212 411.9, filed on Nov. 4, 2021, the disclosure of which is incorporated herein by reference in its entirety.

### FIELD

This disclosure relates to an adjustable stop in accordance with the preamble of the main claim and to an optical arrangement having an adjustable stop and to a method for operating such a stop.

### BACKGROUND

Stops whose aperture widths and, if appropriate, whose aperture shapes can be adjusted and adapted to various applications are frequently used in optical beam paths, both in illumination beam paths and in detection beam paths of optical devices.

Adaptation of the current illumination radiation is of major importance in particular when carrying out microscopy methods in which a sample to be observed is damaged due to excessively intensive illumination radiation (phototoxicity) and/or disadvantageous imaging effects are present. The illumination beam path can be trimmed by means of an adjustable stop.

Stops of this type fulfill different tasks. First, the size of an aperture of the stop determines the proportion of the illumination radiation that reaches the sample. In addition, the illumination radiation can be set such that illumination radiation is incident on the sample only in a region that is currently being observed. Furthermore, the shape of the aperture can be used to both influence the shape of an illuminated region of the sample and to adapt the illuminated region to a shape of a detector for detecting the detection radiation which is present in the detection beam path. By way of example, typical camera chips primarily have rectangular dimensions. Therefore, the use of rectangular stops makes sense in particular in a radiant field stop plane (intermediate image).

Adjustable stops additionally offer the possibility to influence by way of a current positioning of the aperture a resulting position of an illuminated region of the sample. On the other hand, an unintended offset of the aperture in relation to the optical axis, for example, of the illumination beam path may thus occur due to mechanical clearance between the components involved.

The prior art discloses a number of adjustable stops. For example, DD 57 720 discloses an adjustable rectangular stop having two stop slider pairs which are offset relative to each other by 90°. Also frequently used are lamellas that are arranged symmetrically around an optical axis and are simultaneously moved in or out of the beam path, depending on the requirements (see for example DT 25 57 885 A1; DE 80 16 658 U1 and DE 2053 089 A).

### SUMMARY

A disadvantage of the solutions according to the prior art is that the aperture of the adjustable stop can be centered with respect to the optical axis only by using an additional adjustment device. In addition, size and position of the aperture are freely selectable only within narrow limits. This is true in particular if at least two stop elements are mechanically positively coupled to each other. In addition, relatively large positioning inaccuracies may occur due to the clearance in the coupling locations (for example, due to backlash).

As disclosed herein, an adjustable stop allows possible settings of the size and/or the shape of an aperture, which are expanded in particular in comparison with the prior art. In addition, centering of the aperture or maintaining centering are intended to be simplified. Additionally, a method for operating an adjustable stop is disclosed.

Disclosed herein is an adjustable stop for an optical, in particular, a light-optical, beam path. The adjustable stop includes a plurality of stop elements which are each movable in a stop plane that extends laterally, substantially orthogonally, to a through axis. The through axis typically coincides with an optical axis of the beam path. Portions of the stop elements, in particular in each case a segment of a periphery (outer contour and/or inner contour; see below) of the relevant stop element, delimit in each case an aperture around the through axis in certain portions based on their respectively current set position. In addition, drives for setting a respective set position of the stop elements are present.

An adjustable stop can be characterized in that each stop element is embodied in the form of a cam disk or of a sector of a cam disk, which is rotatable about, in each case, an axis of rotation aligned substantially parallel to the through axis. The cam disk has a number of differently shaped portions of its respective periphery with the result that a current set position of the relevant stop element at which a selected peripheral segment forms a portion of the delimitation of the aperture is selected and assumed for the purpose of setting a selected size, shape and/or position of the aperture. A resultant size, shape and/or position of the aperture is obtained by the cooperation of all stop elements in their respective current set positions. The stop elements are designed such that a radial distance of the peripheral segments, in particular of successive peripheral segments, of a stop element from the axis of rotation increases at least over an angular range of the cam disk.

The angular range is at least 90°, advantageously at least 180° or at least 270°. Each stop element thus can be configured as a closed cam disk or in the form of a segment or sector, wherein the angular range of the increasing radial distance of the peripheral segments can be smaller than the entire extent of the stop element.

In one possible embodiment, the increase in the radial distance of the peripheral segments over the angular range can take place continuously. In this case, a peripheral segment is understood to mean a portion of the stop element that has a substantially uniform curve radius. The latter changes slightly over the extent of the peripheral segment, for example, by no more than 5% of the average radial distance of the relevant peripheral segment. The start and end of a peripheral segment of this embodiment are therefore not fixed in advance but established in each case by its current involvement in the delimitation of the aperture.

In further possible embodiments of the adjustable stop, the peripheral segments are formed in each case as rectilinear portions (line portions). Either all lines portions in a successive arrangement or at least two adjacent lines portions with increasing radial distances from the axis of rotation can be formed here and form steps in relation to one another. The line portions can extend tangentially to the curve radius or at an angle that is not 90°, as a result of which the periphery of the stop element takes on a sawtooth-like appearance (referred to below overall as a stepped or step-wise profile). The radial distance of a line portion extending at an angle to the axis of rotation that is not 90°, is defined, for example, at the center of the relevant line portion.

It is possible that a stop element has both a segment having a continuous profile and at least one segment having a stepped or sawtooth-like profile.

In order to permit individual control of all stop elements and thus enable the widest possible variation of the settable sizes and/or shapes of the aperture, each stop element is in further embodiments rotatable independently of the other stop elements about in each case the axis of rotation that is aligned substantially parallel to the through axis. The rotation can here be effected advantageously in a controlled manner by motor or manually.

Motor drives used can be, for example, stepper motors with limit switches (e.g. Hall sensor, slotted optocoupler, reflective coupler), DC motors with encoder/rotary encoder and also upstream transmissions.

However, it is possible in a further embodiment that at least two of the stop elements are coupled together, with the result that their rotations and set positions are brought about by the respectively selected coupling conditions. In such an embodiment, the number of possible settings for the aperture is limited compared to a separate drive for each stop element.

Mechanical coupling or control-technical coupling is an advantage for example if at least one of the peripheral segments of at least one stop element projects beyond the center of the aperture and intersects the through axis. In such an embodiment, the aperture of the adjustable stop can be completely closed. The stop elements arranged in a common stop plane can here be coupled advantageously such that any unwanted collision of the stop elements is prevented. For example, a control-technical coupling can prevent the stop elements from simultaneously being able to assume such set positions at which contact or even collisions may occur. Mechanical coupling for avoiding collisions can be implemented for example by protrusions, abutments or the like, which prevent undesired combinations of set positions.

In addition to the controlled setting of size and/or shape of the aperture, it is also possible by means of the adjustable stop to influence the position of the aperture. The position of the aperture is in particular understood to mean the lateral location of the center, in particular the geometric center, of the aperture in relation to the optical axis of the beam path that is directed through the aperture.

One possibility for setting the position of the aperture consists in selecting set positions of the individual stop elements. For example, the position can be shifted by a small section if the two stop elements that lie opposite each other are set asymmetrically with respect to one another. In this case, the aperture is not limited by such peripheral segments that correspond to one another, but by those having different radial distances.

One further possibility allows a targeted change in the position by a greater distance. In this case, in addition to the rotational movement, at least one of the stop elements can be shiftable in its respective stop plane in a controlled manner. Such a shift can be brought about by means of a further motor drive or manually and permits for example the adjustment of the adjustable stop. The shift can take place along a guide. In further embodiments , a shift can take place within the stop plane, that is to say two-dimensionally. It is likewise additionally or alternatively possible to shift the stop elements in the direction of the z-axis.

The peripheral segments that act as delimitation of the aperture can be an outer contour of the respective stop element. In this way, at least two opposite stop elements can be arranged in a common stop plane without them touching or intersecting.

In further embodiments of the adjustable stop, the peripheral segments form at least portions of an inner contour of the stop element. The stop elements are embodied here, for example, as cam disks having a cutout, through the periphery of which a region of the peripheral segment is formed. The outer contour of the stop element is not relevant in this case for the delimitation of the aperture. If the stop element is shiftable in the stop planes as described above, the shift in the stop plane can in further possible embodiments be effected to such an extent that it is not the inner contour but alternatively a peripheral segment forming the outer contour in portions that delimits the aperture on one side. If a plurality of stop elements are present in a stop whose inner contours serve for delimiting the aperture, they can be arranged in different stop planes so as to avoid collisions.

For reasons relating to the paths taken by individual rays, for example by a beam of rays of illumination radiation, undesired optical effects such as the stopping down of rays and diffraction effects may occur, which are brought about substantially by the design-related offset of the stop elements along the optical axis.

To reduce such effects, the peripheral segments of the stop elements in further embodiments in each case have a chamfer. The chamfers of the stop elements in a stop plane here end at the same position along the optical axis. The chamfers are here advantageously of a type such that they project into the beam path at the same position of a side face of the stop element extending in the respective stop plane (see FIG. 4). In this way, optical effects are reduced that can occur due to the material thickness of the relevant stop element in the direction of the optical axis. As a result of the rather small dimension of the chamfered stop edge, the latter can be arranged very precisely in an intermediate image plane. If a plurality of stop elements are arranged in adjacent stop planes, the respective chamfers can be formed on the side faces of adjacent stop elements that directly lie one next to another.

The angles of the chamfers are advantageously selected such that reflected rays are not incident on the camera or the detector or into the eyepiece and thereby produce disturbing stray light.

With corresponding coordination of the dimensions of the stop elements and their arrangement in the z-direction, it is also possible with the adjustable stop to reduce any longitudinal chromatic aberrations that may occur.

As was already mentioned above in connection with an optional chamfer, stop elements can be arranged in an adjustable stop in the direction of the optical axis in at least two stop planes that are orthogonal to the optical axis. Advantageously, said stop elements are movable in differing directions into the beam path and/or out of it.

For example, the stop elements of the different stop planes can rest against one another in the direction of the optical axis by way of their mutually facing side faces. The contact surfaces formed due to the regions of the side faces that are in contact in this way can advantageously be provided with a glide coating (e.g., Polytetrafluoroethylene; PTFE), which enables low-friction gliding of the side faces onto one another and whose effect reduces static friction effects as can occur, for example, disadvantageously at the beginning of a glide movement.

In further embodiments, a distance (air gap) can be maintained between the stop elements of different stop planes. However, as the distance increases, it becomes more difficult to position all the stop elements, or the corresponding peripheral segments, involved in the optical effect of the adjustable stop in a common plane or within a small section in the direction of the through axis. The common plane is in particular an intermediate image plane.

The adjustable stop can be present and used in an optical arrangement, for example, in an illumination beam path. An illumination beam path can serve for shaping and guiding radiation and for this purpose includes for example optical elements for imaging the radiation into an intermediate image plane. Furthermore, an adjustable stop which is arranged in particular in an intermediate image plane is present. In addition, at least one optical element (objective) for imaging the image of the adjustable stop into a sample space is present. The image of the adjustable stop can also be imaged onto or in an object that is to be illuminated and/or imaged, for example a biological sample or a sample of material. If motor drives for the controlled movement of the stop elements are additionally present, a control unit that is embodied and configured for generating setting commands for the individual drives is present. An illumination beam path as described above can be present in a microscope.

In further embodiments, the optical arrangement can be a detection beam path along which captured detection radiation is directed onto a detector. A detector can be, for example, a camera or a camera chip (e.g. CCD chip, CMOS chip or arrays of photomultipliers or avalanche photodiodes such as PMT arrays; SPAD arrays).

It is possible for an adjustable stop to be arranged in an illumination beam path and/or in a detection beam path in particular of a microscope.

The control unit can be, for example, a computer or an FPGA (field programmable grid array).

In further embodiments of an optical arrangement, the adjustable stop can be arranged outside an intermediate image plane, for example, in a portion of collimated radiation of the beam path.

The adjustable stop enables the setting of a large number of shapes and/or sizes of the aperture. At least some of the possible shapes may in this case not be ideal for light-optical beam shaping. For example, it is possible that specific set positions of the available stop elements may bring about apertures that have a pincushion shape and/or elongated corner regions. In a beam path, in particular in an illumination beam path, it is therefore possible for at least one optical means, such as for example an AOTF (acousto-optic tunable filter), to be present, through whose effect errors and deviations of the beam of rays which occur as a result of such shapes of the aperture are corrected or can be corrected (correction unit). For example, distortions caused by the design of the beam path can be used and/or corresponding distortions can be brought about in order to reduce errors due to the adjustable stop. For example, a pincushion-shaped distortion of the adjustable stop can be at least reduced by a corresponding barrel-shaped distortion in the course of the beam path.

The adjustable stop according to one of the described possible embodiments can be operated by capturing for each stop element its current set position. In addition, an actual embodiment of the stop element as a cam disk is stored so as to be repeatedly retrievable. In this way it is known which peripheral segment or which peripheral segments are currently facing the through axis, which typically coincides with the optical axis. In addition, a desired shape and size to be set and/or position of the aperture that is delimited in portions by the stop elements around the through axis is ascertained. In other words, a determination relating to the aperture to be set is made, and this selection is compared with a currently existing setting of the adjustable stop.

The shape, size and/or position of the aperture can be ascertained iteratively by the stop elements being adjusted starting from a current set situation and at the same time by capturing and evaluating the effect of the aperture that is respectively produced thereby. For example, in each case the signals of a detector can be evaluated and be correlated to current set positions of the stop elements and the resultant aperture. For such a procedure (feedback control), it is possible in particular for a sample having known properties, for example, a reference sample or a reference object, to be illuminated. It is also possible for the respectively required set positions of the stop elements and the required control commands to be ascertained by way of computation, for example, by means of a simulation. Further possibilities are provided by previously created tables (e.g., LUT; lookup table).

The complex interaction of the individual stop elements, in particular if these are rotatable independently of one another and may additionally also be shiftable laterally, can be assessed here advantageously by using a computer.

If the current actual set positions of the stop elements are known and the desired size, shape and/or position of the aperture has/have been ascertained, the stop elements are correspondingly moved into the required predetermined set positions. If this is not done manually, corresponding control commands are generated which, upon execution, bring the stop elements into the ascertained predetermined set positions.

If only the shape and/or size of the aperture is adapted, a virtual center in the aperture remains spatially fixed in each current set position and is intersected by the through axis. In other words, the aperture remains centered relative to the through axis. In addition or alternatively, it is possible for the stop elements to be controlled such that, in addition to the shape and/or size of the aperture, its lateral position is also changed. The virtual center of the aperture is here shifted laterally to the through axis.

### BRIEF DESCRIPTION OF THE DRAWINGS

The apparatuses and techniques are explained in more detail below on the basis of exemplary embodiments and figures. In the figures:

FIG. 1 shows a schematic illustration of a first exemplary embodiment of a stop element with a continuously increasing radial distance;

FIG. 2 shows a schematic illustration of a second exemplary embodiment of a stop element with a radial distance that increases in a step-wise manner;

FIG. 3 shows a schematic illustration of a third exemplary embodiment of a stop element with a radial distance that increases in a step-wise manner and peripheral segments with in each case a chamfer;

FIG. 4 shows an enlarged detail of a first exemplary embodiment of an adjustable stop having chamfered peripheral segments of two stop elements that are arranged one next to the other;

FIG. 5 shows a schematic illustration of a second exemplary embodiment of an adjustable stop having stop elements with a continuously increasing radial distance in a first operating position;

FIG. 6 shows a schematic illustration of the exemplary embodiment of an adjustable stop having stop elements with a continuously increasing radial distance in a second operating position;

FIG. 7 shows a schematic illustration of the exemplary embodiment of an adjustable stop having stop elements with a continuously increasing radial distance in a third operating position;

FIG. 8 shows a schematic enlarged detail illustration of the exemplary embodiment of an adjustable stop having stop elements with a continuously increasing radial distance in the third operating position;

FIG. 9 shows a schematic detail illustration of a third exemplary embodiment of an adjustable stop having stop elements with a radial distance that increases in a step-wise manner in a view obliquely from behind;

FIG. 10 shows a schematic illustration of the third exemplary embodiment of an adjustable stop having stop elements with a radial distance that increases in a step-wise manner in a first operating position;

FIG. 11 shows a schematic illustration of the third exemplary embodiment of an adjustable stop having stop elements with a radial distance that increases in a step-wise manner in a second operating position;

FIG. 12 shows a schematic illustration of the third exemplary embodiment of an adjustable stop having stop elements with a radial distance that increases in a step-wise manner in a third operating position;

FIG. 13 shows a schematic illustration of a fourth exemplary embodiment of an adjustable stop having stop elements with a continuously increasing radial distance and laterally adjustable stop elements;

FIG. 14 shows a schematic illustration of a fifth exemplary embodiment of an adjustable stop having stop elements with a radial distance that increases in a step-wise manner and with adjustable stop elements in four stop planes;

FIG. 15 shows a schematic illustration of a sixth exemplary embodiment of an adjustable stop having stop elements with a radial distance that increases in a step-wise manner, wherein the stop elements are formed by sectors of a cam disk;

FIG. 16 shows a schematic illustration of a fourth exemplary embodiment of a stop element with a radial distance that increases in a step-wise manner, wherein the peripheral segments form an inner contour;

FIG. 17 shows a schematic illustration of a seventh exemplary embodiment of an adjustable stop, wherein the peripheral segments of the stop element have a radial distance that increases in a step-wise manner and form an inner contour;

FIG. 18 shows a schematic illustration of an eighth exemplary embodiment of an adjustable stop having two stop elements that each have at least one helical cutout;

FIG. 19 shows a schematic illustration of a first exemplary embodiment of an optical arrangement having an adjustable stop in the illumination beam path; and

FIG. 20 shows a schematic illustration of a second exemplary embodiment of an optical arrangement having an adjustable stop in the detection beam path.

### DETAILED DESCRIPTION

Identical technical elements will be denoted by the same reference signs in the exemplary embodiments that follow.

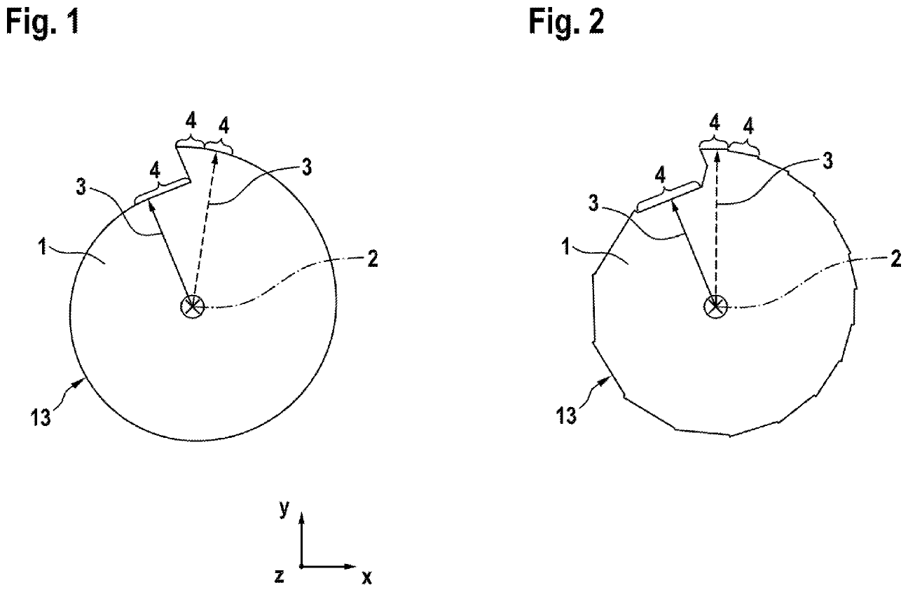

In a first exemplary embodiment of a stop element 1 in the form of a cam disk, the radius between an axis of rotation 2 of the stop element 1 and its periphery continuously increases (FIG. 1). If portions of the circumferential periphery are considered to be peripheral segments 4, their radial distance 3 from the axis of rotation 2 therefore increases over the entire circumference of the stop element 1 and, after a rotation of 360°, jumps back to the initial radial distance 3 (shown by way of example with arrows in a full line and with an interrupted full line). An outer contour 13 of the stop element 1 is defined by the peripheral segments 4. The stop element 1 extends substantially into a plane defined here by the axes x and y of a Cartesian coordinate system. The axis of rotation 2 is directed along the z-axis out of the drawing plane. Such an embodiment permits a definition of the respective portions of the periphery involved in a delimitation of an aperture 9 (see below, FIGS. 4 to 16), that is to say of the peripheral segments 4 thus defined in each case.

In a second exemplary embodiment of the stop element 1, its periphery is formed from individual peripheral segments 4 which are offset from one another in the manner of steps (FIG. 2). The peripheral segments 4 therefore have, over the circumference of the stop element 1, a radial distance 3 from the axis of rotation 2 which increases in a step-wise manner. The peripheral segments 4 facing the aperture 9 in a respective set position of the relevant stop element 1 delimit said aperture 9.

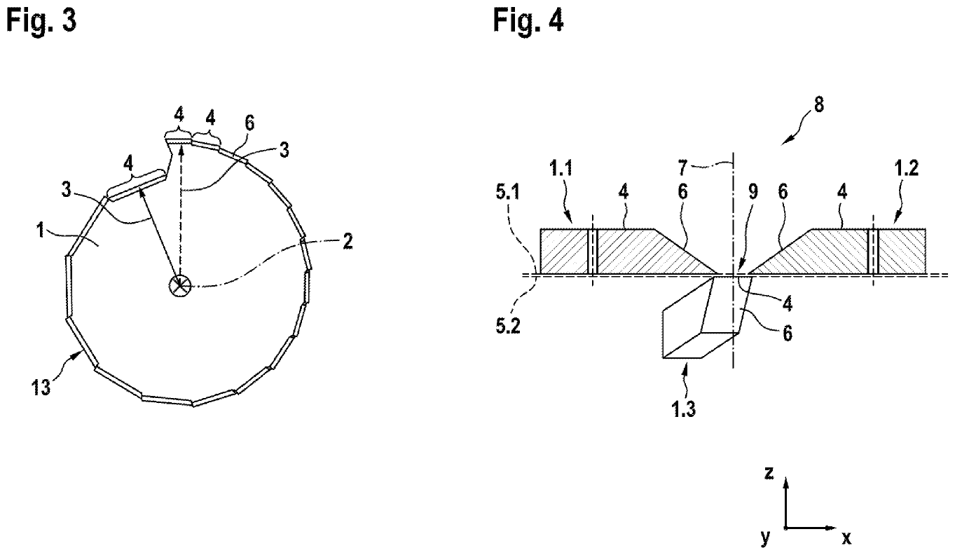

According to a third exemplary embodiment, the stop element 1 can have a number of peripheral segments 4 that are provided with a chamfer 6 (FIG. 3). Such an embodiment can be implemented both on stop elements 1 having a continuous periphery and an increasing radial distance 3, on stop elements 1 having a radial distance 3 that increases in a step-wise manner, and also on stop elements 1 having a radial distance 3 of the peripheral segments 4 that increases continuously in portions or in a step-wise manner.

The chamfer 6 serves for reflecting incident rays of an illumination radiation or detection radiation out of the beam path so as to counteract undesired stray light at the peripheral segment 4 and at an adjustable stop 8 (see FIG. 4).

One possible arrangement of such stop elements 1 in an adjustable stop 8 is illustrated schematically in FIG. 4 in the form of a lateral portion. In the exemplary embodiment, a first stop element 1.1 and a second stop element 1.2 are arranged in a first stop plane 5.1. In the current set positions of the stop elements 1.1 and 1.2, in each case one peripheral segment 4 faces the through axis 7 that coincides with the optical axis of the beam path and they delimit the aperture 9 in the first stop plane 5.1. The chamfer 6 here extends such that it drops obliquely toward the through axis 7. In addition to the arrangement of the two stop elements 1.1 and 1.2, a third stop element 1.3 and a fourth stop element 1.4 are present (for reasons pertaining to the drawing, only a sector of the third stop element 1.3 is illustrated). The effective current width of the aperture 9 is determined by the current set positions of the stop elements 1.1 to 1.4. The chamfers 6 of the stop elements 1.1 to 1.4 extend toward a common virtual point of intersection within the aperture 9. This embodiment together with mounting of the stop elements 1.1 and 1.2 of the first stop plane 5.1 and of the stop elements 1.3 and 1.4 of the second stop plane 5.2 spatially close to each other brings about an effective width of the aperture 9 which is suitable in particular for use in an intermediate image having a low depth of field.

In further possible embodiments of an adjustable stop 8, is also possible for only three stop elements 1.1 to 1.3 to be present, whose axes of rotation 2 are for example directed so as to be parallel and offset with respect to one another by 120°.

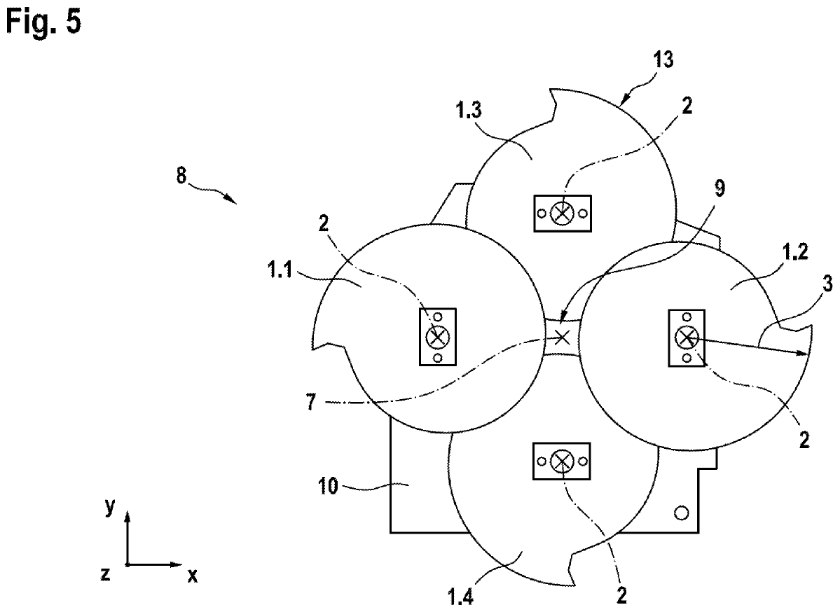

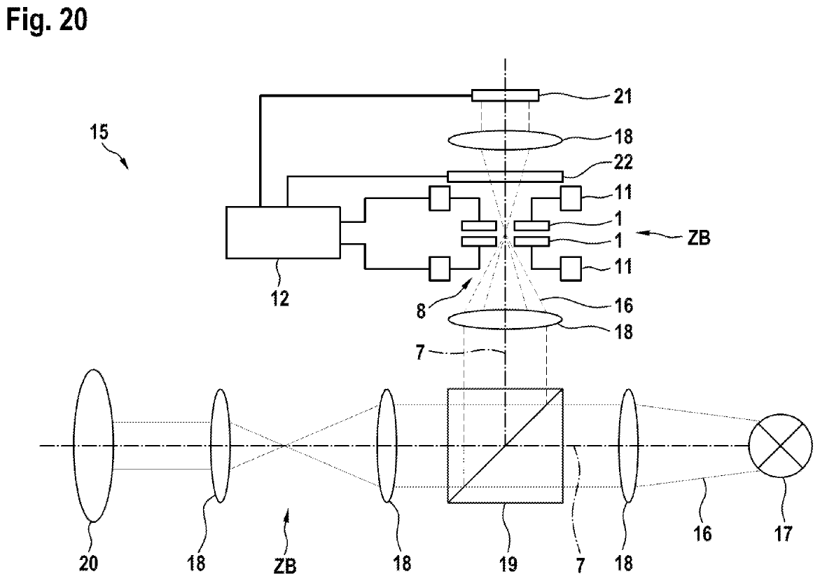

FIG. 5 shows a second exemplary embodiment of the adjustable stop 8 in a view along the z-axis. In the first stop plane 5.1 facing the viewer, the first two stop elements 1.1 and 1.2 are arranged, while the third and fourth stop elements 1.3 and 1.4 are located in the second stop plane 5.2 (see also FIG. 4 for the illustration of the two stop planes). The illustrated stop elements 1.1 to 1.4 are mounted on a carrier plate 10. All stop elements 1.1 to 1.4 have a continuously increasing radial distance 3. In the first operating position shown of the adjustable stop 8, the aperture 9 is delimited by peripheral segments 4 of the stop elements 1.1 to 1.4 and defined with respect to their shape, size and position in relation to the through axis 7. Since the peripheral segments 4 are rounded over their respective profiles, the aperture 9 is slightly shaped like a pincushion. The imaging errors or distortions which are possibly caused thereby can optionally be compensated for using a correction unit 22 arranged in the course of the beam path (see for example FIG. 20).

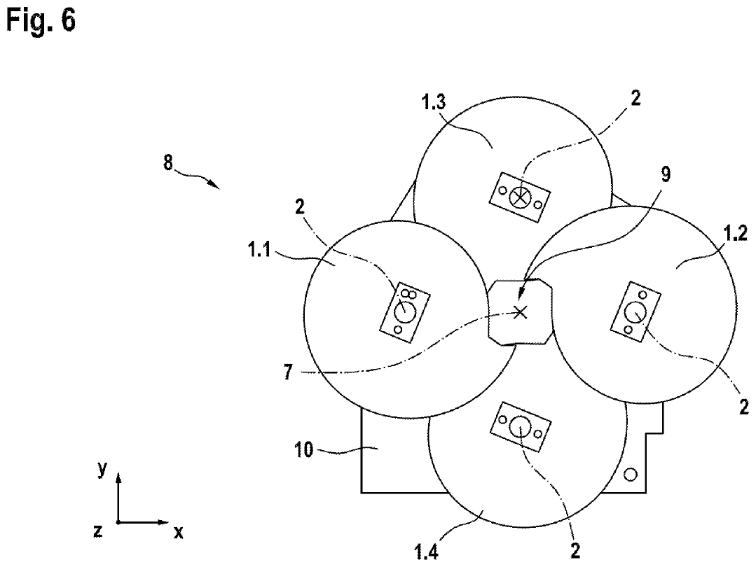

A second operating position of the adjustable stop 8 is shown in FIG. 6. The transition regions at which in each case the peripheral segments 4 having the smallest and the greatest radial distance 3 are directly adjacent to one another are fed to the aperture 9 and delimit it.

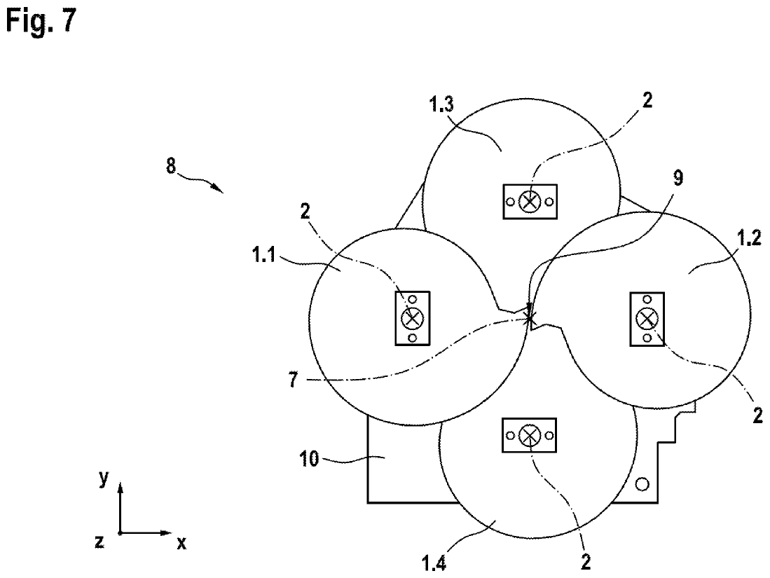

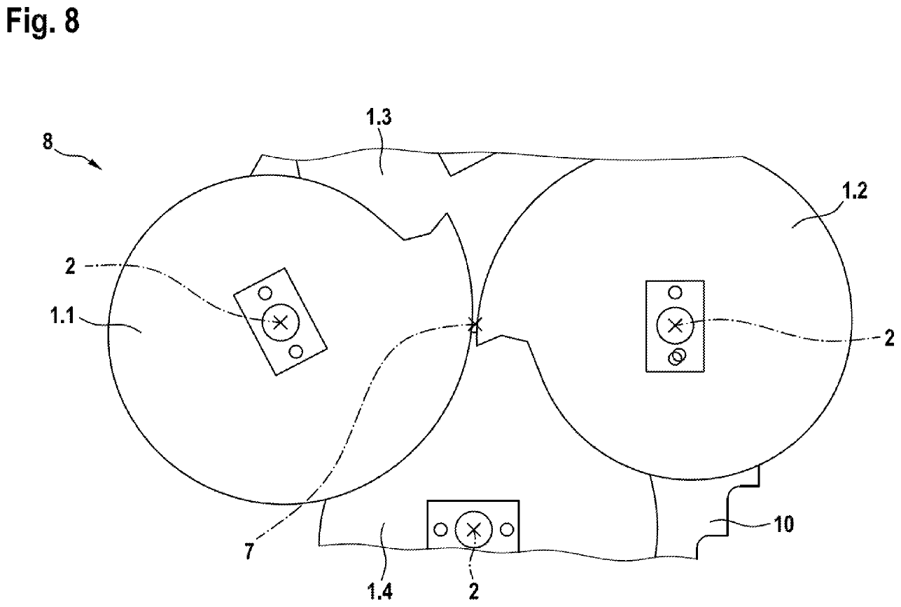

In a third operating position of the adjustable stop 8, which is shown by way of example, the set positions of the stop elements 1.1 to 1.4 are selected such that the transition regions are fed as closely as possible to one another and, as a result, the smallest possible aperture 9 is present along the through axis 7, as is shown in FIG. 7 and FIG. 8 (enlarged detail illustration).

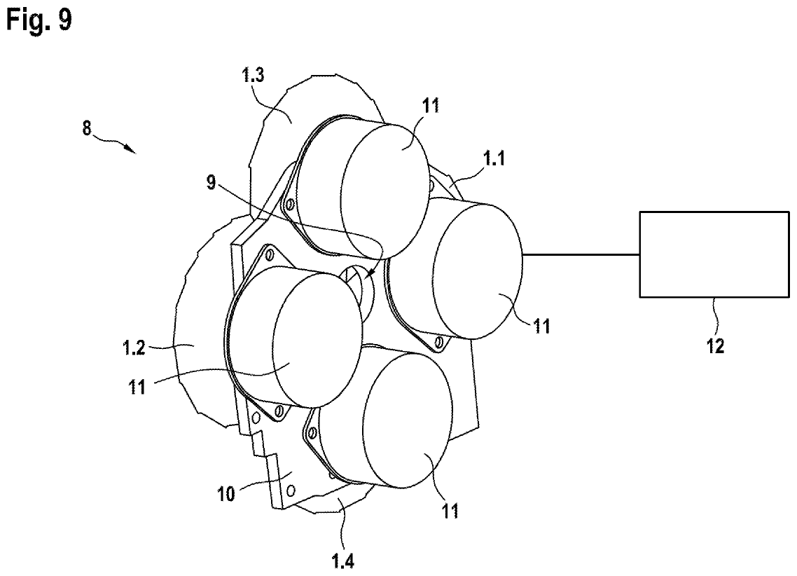

In a third exemplary embodiment of an adjustable stop 8, stop elements 1.1 to 1.4 which have a radial distance 3 that increases in a step-wise manner are present. In a view obliquely from behind (FIG. 9), one drive 11 for each stop element 1.1 to 1.4 is shown, which drives are advantageously actuated by motor and are controllable by means of a control unit 12 via suitable data lines (only one of which is shown by way of example). Alternatively, drives 11 that can be actuated manually may be provided. In one embodiment, the stop elements 1.1 to 1.4, or further ones, are supported by the support of the respective drives 11. Alternatively, they can have a separate bearing. They are then suitably connected, mechanically and for transmitting actuating forces, to the driver 11 via a coupling or directly.

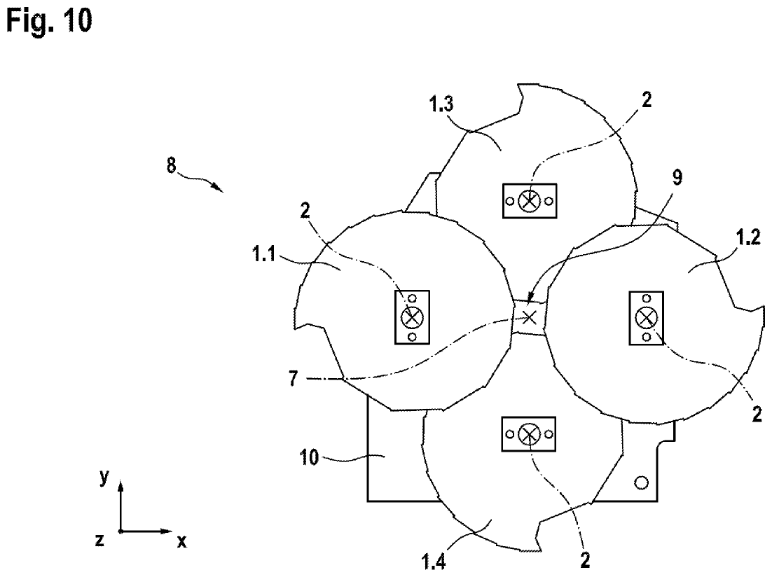

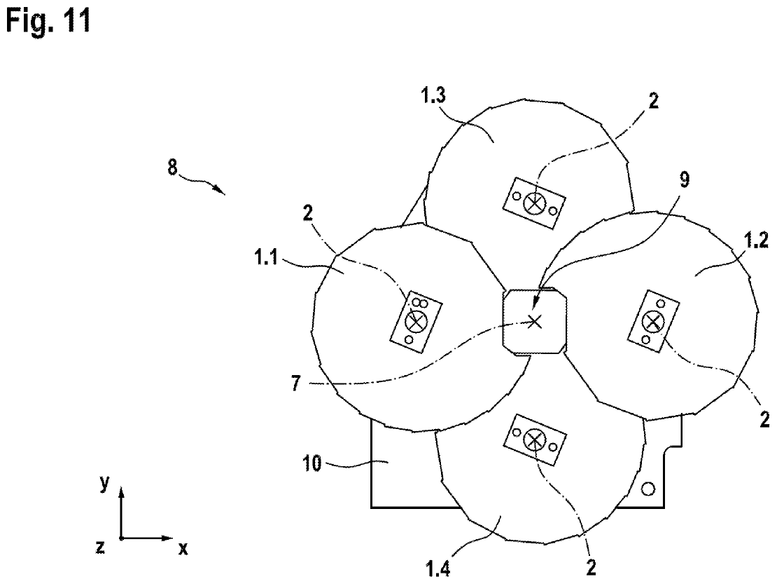

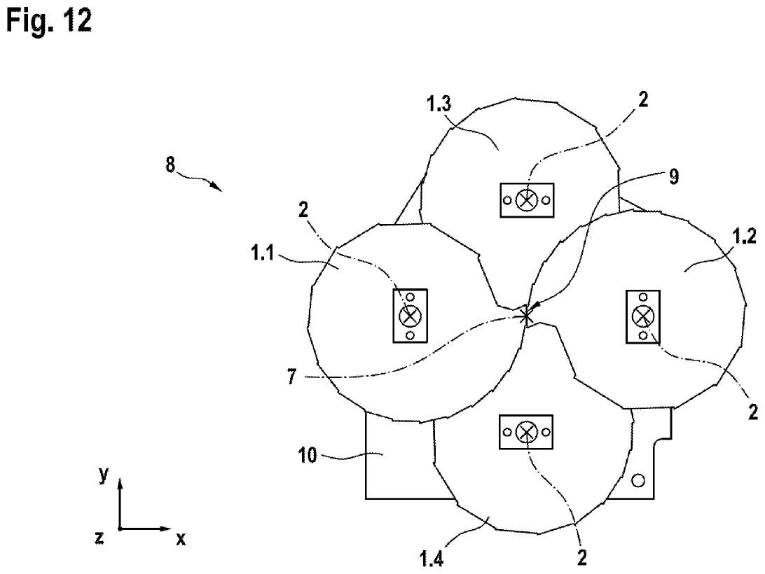

The adjustable stop 8 according to the third exemplary embodiment is shown in FIG. 10 in a first operating position, in FIG. 11 in a second operating position, and in FIG. 12 in a third operating position (analogously to FIG. 5 to FIG. 7). As is shown by way of example in FIG. 10, in many of the possible combinations of set positions of the stop elements 1.1 to 1.4 the aperture 9 does not cause any for example pincushion-type distortions due to the peripheral segments 4 being straight in portions (see, by contrast, FIGS. 5 and 6).

In embodiments of the adjustable stop 8, the stop elements 1.1 and 1.2 and also 1.3 and 1.4 of a respective stop plane 5.1 and 5.2, respectively, are arranged relative to one another such that collisions within the respective stop planes 5 are avoided. This distance is advantageously set to be as small as possible in the direction of the through axis 7 (direction of the z-axis) in order to position the peripheral segments 4 at the aperture 9 within the depth of field of the intermediate image ZB. During an optionally possible initialization movement, intelligent movement conditions should be observed so as to avoid collisions.

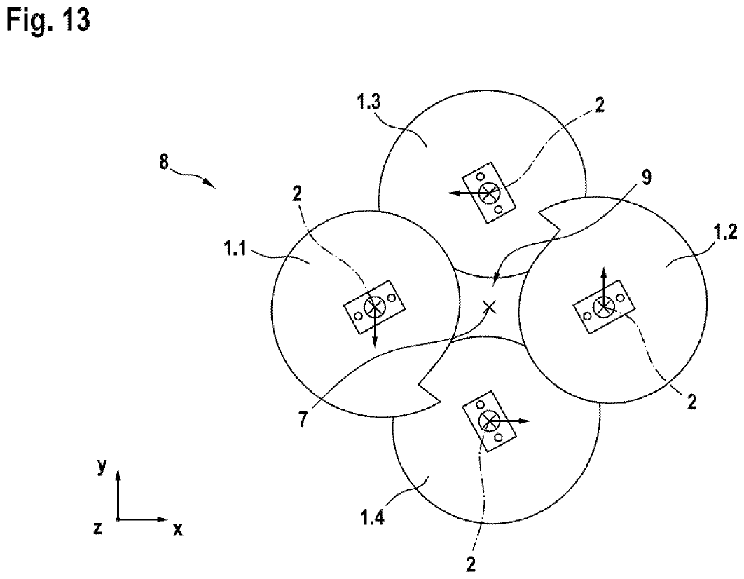

This avoidance of collisions is crucial in particular in a fourth exemplary embodiment of the adjustable aperture 8, in which the stop elements 1.1 to 1.4 are laterally adjustable in each case individually or with mutual coordination. Such a lateral adjustment possibility is illustrated in FIG. 13 by way of example using arrows at the respective axes of rotation 2. In addition to setting different sizes of the aperture 9, such a lateral adjustment possibility can also be used to change the position of the aperture 9 in particular with respect to the through axis 7.

In a further possible embodiment , the stop elements 1 can be arranged in the respective stop planes 5 so as to be laterally displaced relative to one another. In summary, the resultant feed directions of the peripheral segments 4 in a top view of the stop 8 are not approximately 90° but can deviate therefrom for example up to 45°. Such an arrangement of the stop elements 1 relative to one another can bring about, for example, the shape of a “pincushion” of the aperture 9 uniformly around the optical axis in order to reduce the disadvantageous effect of such a shape of the aperture 9. In an alternative embodiment, all or selected stop elements 1 present can be rotated as a whole about the axis of rotation 7 in order to thereby achieve a shape of the aperture 9 that causes small imaging aberrations.

In further embodiments , the stop elements 1 can be adjusted laterally, that is to say in an x-y plane and/or in the direction of the z-axis (z-direction). In this way, the stop elements can be tilted in order to transform for example a helical profile of the peripheral segments into a circular profile.

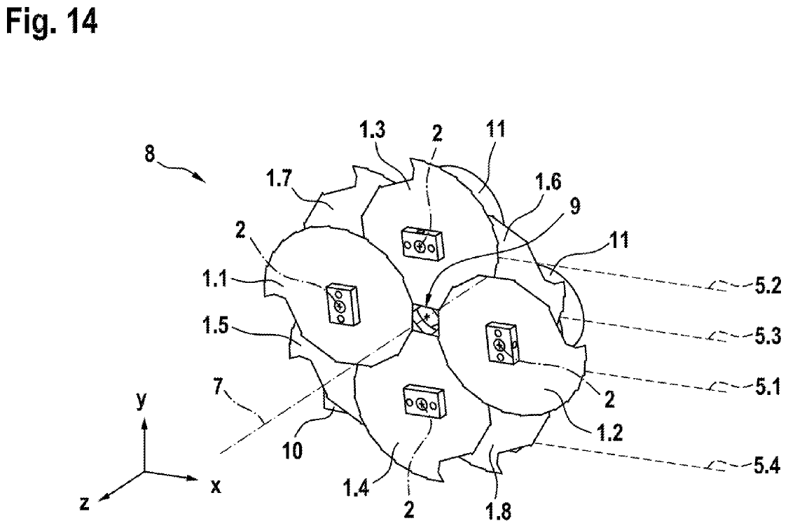

The exemplary embodiments of an adjustable stop 8 which have been shown so far included stop elements 1 in two stop planes 5.1 and 5.2. In further embodiments, more stop elements 1 and further stop planes 5 may be present, as is shown by way of example in FIG. 14. In addition to the stop elements 1.1 to 1.4 in the two stop planes 5.1 and 5.2, two further stop elements 1.5 and 1.6 are arranged in a third stop plane 5.3 and stop elements 1.7 and 1.8 are arranged in a fourth stop plane 5.4. In the illustrated exemplary embodiment, the respective radial distance 3 (see FIGS. 1 to 3) increases in a step-wise manner. In further possible embodiments, the radial distance 3 can increase continuously. Advantageously, the stop elements 1.1 to 1.8 are mounted close to one another along the through axis 7 in order to lie for example within the depth of field of an intermediate image.

It is also possible that stop elements 1 having a step-wise increase and stop elements 1 having a continuous increase of the radial distance 3 are combined in an adjustable stop 8 of any possible embodiment. For example, in each case one embodiment can be arranged in the different stop planes 5. Furthermore, stop elements 1 on which in each case both sectors having a step-wise increase and having a continuous increase of the radial distance 3 are present can be present in all exemplary embodiments. All these options can additionally be combined with one another.

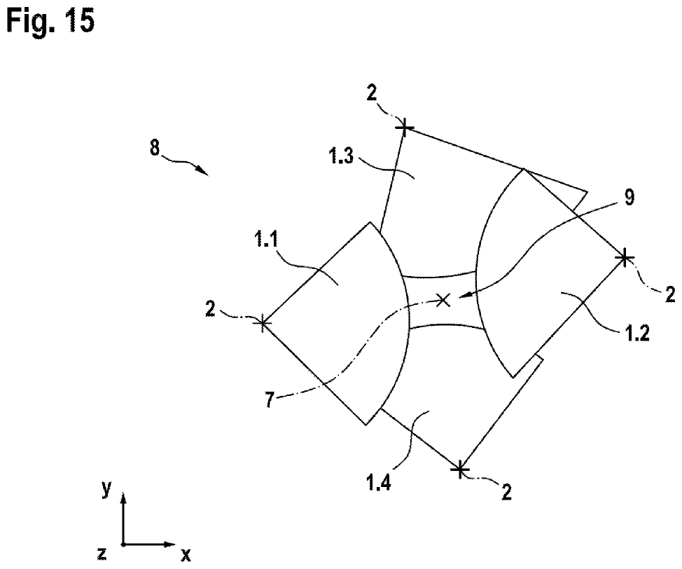

In a further exemplary embodiment , the stop elements 1, for example 1.1 to 1.4 (FIG. 15), can be in the form of sectors of a cam disk. This may reduce the number of possible designs of the aperture 9, but the required installation space for the adjustable stop 8 can advantageously be reduced. In the exemplary embodiment illustrated, the stop elements 1.1 to 1.4 are embodied in each case as a quarter cam disk and have a continuous increase of the radial distance 3.

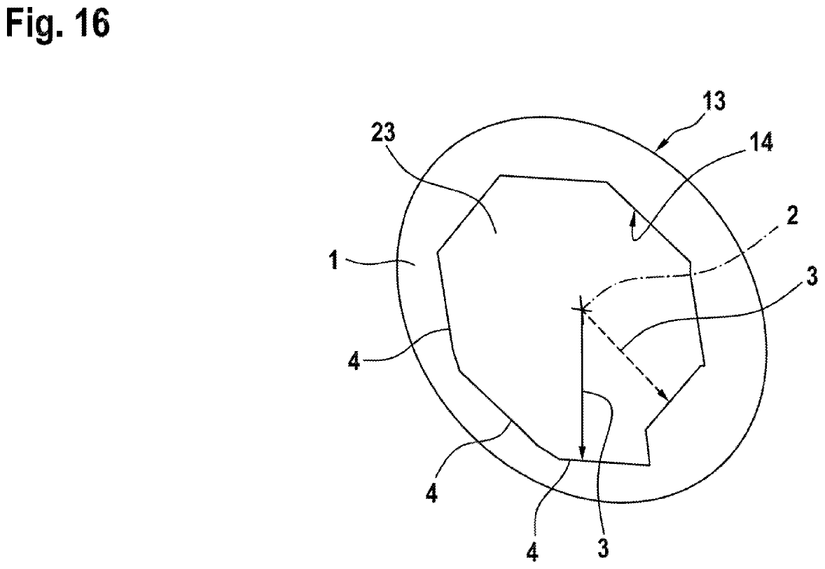

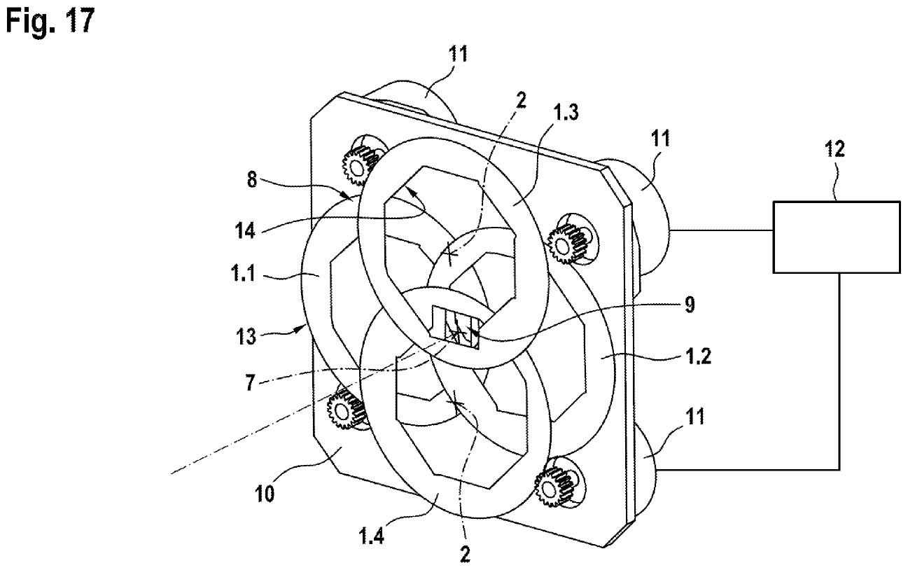

In embodiments that have been described so far, the outer contour 13 of the respective stop element 1 is formed and provided for delimiting the aperture 9. In further possible embodiments of the stop elements 1, an inner contour 14, which is provided for delimiting the aperture 9 (see for example FIG. 17), can be formed by the peripheral segments 4 (only some of which are designated by way of example). FIG. 16 shows such a stop element 1 with a radial distance 3 of the peripheral segments 4 from the axis of rotation 2 that increases in a step-manner. The stop element 1 of course also has an outer contour 13.

Stop elements 1 having inner contours 14 can be used in an adjustable stop 8 in accordance with FIG. 17. The stop elements 1.1 to 1.4 are arranged in four stop planes 5.1 and 5.4 (see also FIG. 14) in a manner such that their peripheral segments 4 delimit the aperture 9 depending on the individual set position and correspondingly define a shape, size and/or position of the aperture 9. The individual stop elements 1.1 to 1.4 can be rotated by means of individual drives 11, which engage with the respective outer contour 13 for example by means of a gearwheel or friction wheel.

In further variants of the adjustable stop 8, the stop elements 1.1 to 1.4 can be laterally adjusted such that, rather than the inner contour 14 of at least one stop element 1.1 to 1.4, its outer contour 13 serves as the delimitation of the aperture 9 (not shown).

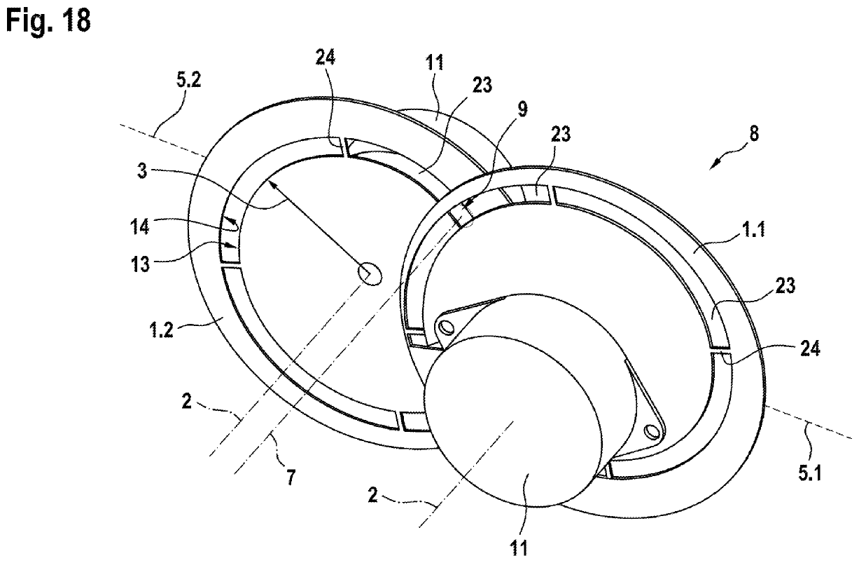

A further possible embodiment of an adjustable stop 8 has, for example, two stop elements 1.1 and 1.2 (FIG. 18). The first stop element 1.1 is located in the first stop plane 5.1, while the second stop element 1.2 is arranged in the second stop plane 5.2. The stop elements 1.1 and 1.2 each have at least one cutout 23. The cutouts 23 are formed to be narrow compared to the base area of the respective stop element 1.1, 1.2 and, for example, as helically arranged slots. The profile of each of the cutouts 23 shows a varying radial distance 3 (shown only once) from the axis of rotation 2. In addition, the clear width of each cutout 23 can vary over the profile. Webs 24 by which an inner part of the stop element 1.1, 1.2 is mechanically connected to an outer part of the stop element 1.1, 1.2 are present.

In further possible embodiments , at least in each case two cutouts 23 can be formed in a stop element 1.1 and/or 1.2. A movement to assume a respective set position of the stop element 1.1, 1.2 must then be controlled in a manner such that the cutouts 23 do not intersect in an undesired manner.

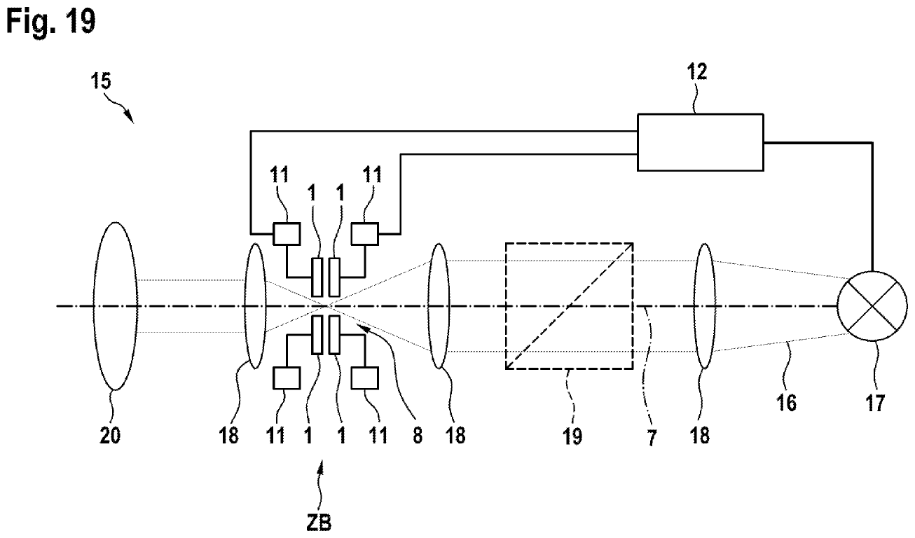

The stop 8 can in one of its embodiments be an integral part of an optical arrangement 15 with an adjustable stop 8 (FIG. 19). The optical arrangement 15 can thus be an illumination beam path 16, along which a radiation is guided starting from a light source 17. The radiation coming divergently from the light source 17 is collimated by means of optical elements 18, in particular by means of optical lens elements, and is directed into a further optical element 18 by an optionally present color splitter 19. Through the action thereof, the radiation is directed into an intermediate image plane ZB, in which the adjustable stop 8 is arranged. Depending on the current setting of the stop elements 1 of the adjustable stop 8, the radiation is shaded in the intermediate image plane ZB. The radiation thus stopped down is guided by means of further optical elements 18 to an objective 20 and is directed by its action for example into a sample space or onto a sample that is located there (neither is shown).

The drives 11 of the stop elements 1 and the light source 17 can be set or controlled in a closed loop by means of the control unit 12.

The adjustable stop 8 can also be arranged in a beam path 16, in the form of a detection beam path, of an optical arrangement 15, for example of a microscope 15 (FIG. 20). A sample can be illuminated here (not shown) as described in FIG. 19, wherein, although there is no need for a stop to be present in the intermediate image plane ZB of the illumination beam path, it may be present, as indicated for example in FIG. 18.

The detection radiation collected by means of the objective 20 is reflected into the detection beam path under the action of the color splitter 9 (interrupted full line) and directed by means of an optical element 18 into an intermediate image plane ZB in which the adjustable stop 8 is arranged. According to the current set position of the stop elements 1, marginal rays of the detection radiation are stopped down, as is shown schematically. The remaining rays pass through the aperture 9 of the adjustable stop 8 to a correction unit 22, which is optionally present in the beam path and by means of which imaging errors, such as distortions, can be reduced. The corrected detection radiation is imaged onto a detector 21 and captured.

The drives 11, the light source 17, the detector 21 and/or the correction unit 22 are connected to the control unit 12 and can be controlled thereby in a closed loop. The control unit 12 can additionally be configured such that it evaluates the captured image data of the detector 21. It may be a goal of the evaluation to ascertain data relating to the optical action of the current settings of the light source 17, the adjustable stop 8 and/or the correction unit 22 and to generate, based on these data, where required, control commands which, when executed, change the optical actions in a desirable manner or enable a reaction to a changed imaging situation (for example a different sample and/or a different imaging method).

1-15. (canceled)

16. An adjustable stop for an optical beam path, the adjustable stop comprising:
a plurality of stop elements, each stop element being movable in a stop plane that extends laterally from a through axis of the adjustable stop, wherein portions of a periphery of each stop element delimit an aperture around the through axis based on a respective current set position of the stop element; and
one or more drives configured for setting the respective current set position of each stop element,
wherein each stop element is embodied in the form of a cam disk or of a sector of a cam disk, which is rotatable about an axis of rotation aligned substantially parallel to the through axis,
wherein each stop element has a number of differently shaped peripheral segments so that the current set position of the stop element configured to be selected to set a selected size and/or shape of the aperture, such that a desired peripheral segment of the stop element forms a portion of the delimitation of the aperture,
wherein the peripheral segments of the stop elements include a chamfer, and
wherein a radial distance of the peripheral segments of a stop element increases over an angular range of the stop element toward the axis of rotation.

17. The adjustable stop according to claim 16, wherein the angular range is at least 90°.

18. The adjustable stop according to claim 16, wherein the angular range is at least 180°.

19. The adjustable stop according to claim 16, wherein the angular range is at least 270°.

20. The adjustable stop according to claim 16, wherein at least two of the stop elements are coupled together, with the result that their rotations and set positions are brought about by the respectively selected coupling conditions.

21. The adjustable stop according to claim 16, wherein each stop element is rotatable independently of the other stop elements about the axis of rotation that is aligned substantially parallel to the through axis.

22. The adjustable stop according to claim 16, wherein the radial distance increases continuously over the angular range.

23. The adjustable stop according to claim 16, wherein the peripheral segments are embodied in each case as line portions.

24. The adjustable stop according to claim 16, wherein, in addition to the rotational movement, at least one of the stop elements is shiftable in the respective stop plane in a controlled manner.

25. The adjustable stop according to claim 16, wherein the peripheral segments form an outer contour of the stop element.

26. The adjustable stop according to claim 16, wherein the peripheral segments form an inner contour of the stop element.

27. The adjustable stop according to claim 16, wherein the stop elements are arranged in at least two stop planes that extend laterally in the direction from the through axis.

28. The adjustable stop according to claim 27, wherein the stop elements of adjacent stop planes rest laterally against each another and the resulting contact faces are provided with a glide coating.

29. An optical system for shaping and guiding radiation, the optical system comprising:
optical elements for imaging the radiation into an intermediate image plane;
an adjustable stop located in the intermediate image plane, the adjustable stop including:
a plurality of stop elements, each stop element being movable in a stop plane that extends laterally from a through axis of the adjustable stop, wherein portions of a periphery of each stop element delimit an aperture around the through axis based on a respective current set position of the stop element; and
one or more drives configured for setting the respective current set position of each stop element,
wherein each stop element is embodied in the form of a cam disk or of a sector of a cam disk, which is rotatable about an axis of rotation aligned substantially parallel to the through axis,
wherein each stop element has a number of differently shaped peripheral segments so that the current set position of the stop element configured to be selected to set a selected size and/or shape of the aperture, such that a desired peripheral segment of the stop element forms a portion of the delimitation of the aperture,
wherein the peripheral segments of the stop elements include a chamfer, and
wherein a radial distance of the peripheral segments of a stop element increases over an angular range of the stop element toward the axis of rotation; and
at least one optical element configured for imaging an image of the adjustable stop into a sample space.

30. The optical system of claim 29, further comprising:
at least one correction unit configured for compensating imaging errors caused by the effect of the adjustable stop.

31. The method for operating an adjustable stop that includes:
a plurality of stop elements, each stop element being movable in a stop plane that extends laterally from a through axis of the adjustable stop, wherein portions of a periphery of each stop element delimit an aperture around the through axis based on a respective current set position of the stop element; and
one or more drives configured for setting the respective current set position of each stop element,
wherein each stop element is embodied in the form of a cam disk or of a sector of a cam disk, which is rotatable about an axis of rotation aligned substantially parallel to the through axis,
wherein each stop element has a number of differently shaped peripheral segments so that the current set position of the stop element configured to be selected to set a selected size and/or shape of the aperture, such that a desired peripheral segment of the stop element forms a portion of the delimitation of the aperture,
wherein the peripheral segments of the stop elements include a chamfer, and
wherein a radial distance of the peripheral segments of a stop element increases
over an angular range of the stop element toward the axis of rotation, the method comprising:
capturing the current set position for each stop element;
determining a desired shape and size and/or position of the aperture that is delimited by the stop elements around the through axis; and
moving the stop elements into predetermined set positions according to the determined desired shape and size and/or position of the aperture.

32. The method of claim 31, further comprising storing, a design as the cam disk of each step element.
